(19) United States
(12) Patent Application Publication
(10) Pub. No.: US 2025/0363439 A1
(43) Pub. Date: Nov. 27, 2025

(54) SYSTEM AND METHOD FOR ASSESSING QUALITY OF DATA FABRIC

(71) Applicant: JPMorgan Chase Bank, N.A., New York, NY (US)

(72) Inventors: Bhuvana PERUMAL, Bengaluru (IN); Amit P SINGH, Bangalore (IN); Siddharth JOSHI, Bengaluru (IN)

(73) Assignee: JPMorgan Chase Bank, N.A., New York, NY (US)

(21) Appl. No.: 18/768,794

(22) Filed: Jul. 10, 2024

(30) Foreign Application Priority Data
May 27, 2024 (IN) 202411040903

(51) Int. Cl. G06Q 10/0639; H04L 41/14

(52) U.S. Cl. CPC G06Q 10/06393; H04L 41/14

(57) ABSTRACT

A system and method for assessing a quality of a data fabric are disclosed. The method includes: receiving a plurality of input data products from at least one data source into the data fabric; and transmitting the plurality of input data products to a quality scoring engine for assessing the quality of the data fabric based on an analysis of each of the plurality of input data products. The analysis includes receiving a plurality of scoring parameters, rule definitions, and a metadata for each of the plurality of input data products; calculating a respective data offering quality score against each of the plurality of scoring parameters during the lifecycle of the plurality of input data products; generating a data fabric quality scoreboard based on an aggregation of the respective data offering quality scores calculated for each of the input data product; and displaying the data fabric quality scoreboard.

### CROSS-REFERENCE TO RELATED APPLICATIONS

This application claims priority benefit from Indian Application No. 202411040903, filed on May 27, 2024 in the India Patent Office, which is hereby incorporated by reference in its entirety.

### FIELD OF THE DISCLOSURE

This technology generally relates to the processing of a data fabric, and more particularly relates to methods and systems for assessing or measuring a quality of the data fabric based on scoring parameters.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The growing use of the internet by individuals, businesses, and other entities, along with the general growth in available data, has resulted in the accumulation of enormous and complex datasets. Furthermore, due to continuous increments of data sets, data systems (such as a big data ecosystem) constantly expand with a wide variety of organized, semi-structured, and unstructured data. Hence, efficient data management of such data systems is a necessity for organizations or business entities, including banks, financial institutions, and technology companies.

One of the existing technologies used for data management and data integration is a data fabric. The data fabric is an architecture that facilitates the end-to-end integration of various data pipelines, on-premises, and cloud environments through the use of intelligent and automated systems. The data fabric provides mechanisms to unify disparate data systems, embed governance, strengthen security and privacy measures, and provide more data accessibility to end users. The data fabric abstracts away the technological complexities engaged for data movement, transformation, and integration, making all data available across the enterprise. For example, banking technology has started implementing a logical data fabric through data virtualization that integrates multiple data sources and provides a data market place for users to discover data products and query data. When integrating data from multiple sources into the data fabric, the quality of the data fabric layer tends to degrade. Further, the existing tools fail to provide monitoring and tracking ability related to the maturity level of the data integration and consumption within the data fabric.

Hence, in view of these and other existing limitations, there arises an imperative need to provide an efficient solution to overcome the above-mentioned limitations and to provide a method and a system for monitoring and tracking the quality of data within the data fabric.

### SUMMARY

The present disclosure, through one or more of its various aspects, embodiments, and/or specific features or sub-components, provides, inter alia, various systems, servers, devices, methods, media, programs, and platforms for assessing quality of data fabric.

According to an aspect of the present disclosure, a method for assessing a quality of a data fabric is disclosed. The method is implemented by at least one processor. The method includes receiving, by the at least one processor, a plurality of input data products from at least one data source into the data fabric. Next, the method includes transmitting, by the at least one processor, the plurality of input data products to a quality scoring engine installed within the data fabric. Next, the method includes assessing, by the at least one processor using the quality scoring engine, the quality of the data fabric based on an analysis of each of the plurality of input data products during a lifecycle of each corresponding input data product within the data fabric. The analysis of each of the plurality of input data products includes receiving, by the at least one processor, a plurality of scoring parameters, a plurality of rule definitions, and a metadata for each of the plurality of input data products. Next, the method includes calculating, by the at least one processor, a respective data offering quality score against each of the plurality of scoring parameters during the lifecycle of each of the plurality of input data products within the data fabric, each respective data offering quality score being calculated based on an application of the plurality of rule definitions against each of the plurality of input data products. Next, the method includes generating, by the at least one processor, a data fabric quality scoreboard based on an aggregation of the respective data offering quality scores calculated for each of the plurality of input data products. Next, the method includes displaying, by the at least one processor, the data fabric quality scoreboard via a user interface (UI) for evaluating the quality of the data fabric.

In accordance with an exemplary embodiment, the plurality of input data products may include data owning system details, a first data product, and data offering details.

In accordance with an exemplary embodiment, the analysis of each of the plurality of input data products within the data fabric may be performed in a sequential manner.

In accordance with an exemplary embodiment, the plurality of scoring parameters may include a set of categories and a set of subcategories, and the set of categories of the plurality of scoring parameters may include at least one from among a data product maturity category, a data product development lifecycle category, a performance optimization category, and a usage category.

In accordance with an exemplary embodiment, the set of subcategories of the plurality of scoring parameters may include at least one from among an onboarding data subcategory, a raw data exposure subcategory, and a data product offering subcategory.

In accordance with an exemplary embodiment, the metadata may include at least one from among a data owning system identifier, a data owning system name, a data owning system description, a data domain name, a data domain description, a data offering identifier, and a data offering name.

In accordance with an exemplary embodiment, each of the plurality of rule definitions may be customized based on a type of the plurality of input data products.

According to another aspect of the present disclosure, a computing device configured to implement an execution of a method for assessing a quality of a data fabric is disclosed. The computing device includes a processor; a memory; and a communication interface coupled to each of the processor and the memory. The processor may be configured to receive a plurality of input data products from at least one data source into the data fabric. Next, the processor may be configured to transmit the plurality of input data products to a quality scoring engine installed within the data fabric. Next, the processor may be configured to assess, using the quality scoring engine, the quality of the data fabric based on an analysis of each of the plurality of input data products during a lifecycle of each corresponding input data product within the data fabric. To perform the analysis of each of the plurality of input data products, the processor may be further configured to receive a plurality of scoring parameters, a plurality of rule definitions, and a metadata for each of the plurality of input data products. Next, the processor may be further configured to calculate a respective data offering quality score against each of the plurality of scoring parameters during the lifecycle of each of the plurality of input data products within the data fabric, each respective data offering quality score being calculated based on an application of the plurality of rule definitions against each of the plurality of input data products. Next, the processor may be further configured to generate a data fabric quality scoreboard based on an aggregation of the respective data offering quality scores calculated for each of the plurality of input data products. Next, the processor may be further configured to display the data fabric quality scoreboard via a user interface (UI) to evaluate the quality of the data fabric.

In accordance with an exemplary embodiment, the plurality of input data products may include data owning system details, a first data product, and data offering details.

In accordance with an exemplary embodiment, the processor may be configured to perform the analysis of each of the plurality of input data products within the data fabric in a sequential manner.

In accordance with an exemplary embodiment, the plurality of scoring parameters may include a set of categories and a set of subcategories, and the set of categories of the plurality of scoring parameters may include at least one from among a data product maturity category, a data product development lifecycle category, a performance optimization category, and a usage category.

In accordance with an exemplary embodiment, the set of subcategories of the plurality of scoring parameters may include at least one from among an onboarding data subcategory, a raw data exposure subcategory, and a data product offering subcategory.

In accordance with an exemplary embodiment, the metadata may include at least one from among a data owning system identifier, a data owning system name, a data owning system description, a data domain name, a data domain description, a data offering identifier, and a data offering name.

In accordance with an exemplary embodiment, each of the plurality of rule definitions may be customized based on a type of the plurality of input data products.

According to yet another aspect of the present disclosure, a non-transitory computer-readable storage medium storing instructions for assessing a quality of a data fabric is disclosed. The instructions include executable code which, when executed by a processor, may cause the processor to receive a plurality of input data products from at least one data source into the data fabric; transmit the plurality of input data products to a quality scoring engine installed within the data fabric; and assess, using the quality scoring engine, the quality of the data fabric based on an analysis of each of the plurality of input data products during a lifecycle of each corresponding input data product. within the data fabric The processor may be further caused to perform the analysis of each of the plurality of input data products by performing each of the following operations: receive a plurality of scoring parameters, a plurality of rule definitions and a metadata for each of the plurality of input data products; calculate a respective data offering quality score against each of the plurality of scoring parameters during the lifecycle of each of the plurality of input data products within the data fabric, wherein each respective data offering quality score is calculated based on an application of the plurality of rule definitions against each of the plurality of input data products; generate a data fabric quality scoreboard based on an aggregation of the respective data offering quality scores calculated for each of the plurality of input data products; and display the data fabric quality scoreboard via a user interface (UI) to evaluate the quality of the data fabric.

In accordance with an exemplary embodiment, the plurality of input data products may include data owning system details, a first data product, and data offering details.

In accordance with an exemplary embodiment, the analysis of each of the plurality of input data products within the data fabric may be performed in a sequential manner.

In accordance with an exemplary embodiment, the plurality of scoring parameters may include a set of categories and a set of subcategories, and the set of categories of the plurality of scoring parameters may include at least one from among a data product maturity category, a data product development lifecycle category, a performance optimization category, and a usage category. The set of subcategories of the plurality of scoring parameters may include at least one from among an onboarding data subcategory, a raw data exposure subcategory, and a data product offering subcategory.

In accordance with an exemplary embodiment, the metadata may include at least one from among a data owning system identifier, a data owning system name, a data owning system description, a data domain name, a data domain description, a data offering identifier, and a data offering name.

In accordance with an exemplary embodiment, each of the plurality of rule definitions may be customized based on a type of the plurality of input data products.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for assessing a quality of a data fabric, in accordance with an exemplary embodiment of the present disclosure.

FIG. 2 illustrates an exemplary diagram of a network environment for assessing a quality of a data fabric, in accordance with an exemplary embodiment of the present disclosure.

FIG. 3 illustrates an exemplary system for assessing a quality of a data fabric, in accordance with an exemplary embodiment of the present disclosure.

FIG. 4 illustrates an exemplary method flow diagram for assessing a quality of a data fabric, in accordance with an exemplary embodiment of the present disclosure.

FIG. 5 illustrates a process flow diagram usable for assessing a quality of a data fabric, in accordance with an exemplary embodiment of the present disclosure.

FIG. 6 illustrates an exemplary system flow diagram of a data fabric quality scoring module for assessing the quality of the data fabric, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable mediums having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the above-mentioned problems, the present disclosure provides a method and system for assessing a quality of a data fabric. To measure the quality of the data fabric, the present disclosure receives a plurality of input data products from at least one data source into the data fabric. The present disclosure allows a user (for example, a technology owner or an end user associated with a data fabric platform) to evaluate the quality of the data fabric based on a data fabric quality scoreboard. The present disclosure utilizes a quality scoring engine (also referred to as a data fabric quality scoring module) that allocates a score for each milestone that is accomplished by each of the plurality of input data products and tracks the journey from foundational to mature resolution for the plurality of input data products. More particularly, the present disclosure receives a plurality of scoring parameters, rule definitions, and a metadata for each of the plurality of input data products. Next, the present disclosure calculates a respective data offering quality score against each of the plurality of scoring parameters during a lifecycle of each of the plurality of input data products within the data fabric. Further, the present disclosure generates the data fabric quality scoreboard based on an aggregation of the respective data offering quality scores calculated for each of the plurality of input data products. Finally, the present disclosure displays the data fabric quality scoreboard via a user interface (UI) to allow the user to evaluate the quality of the data fabric.

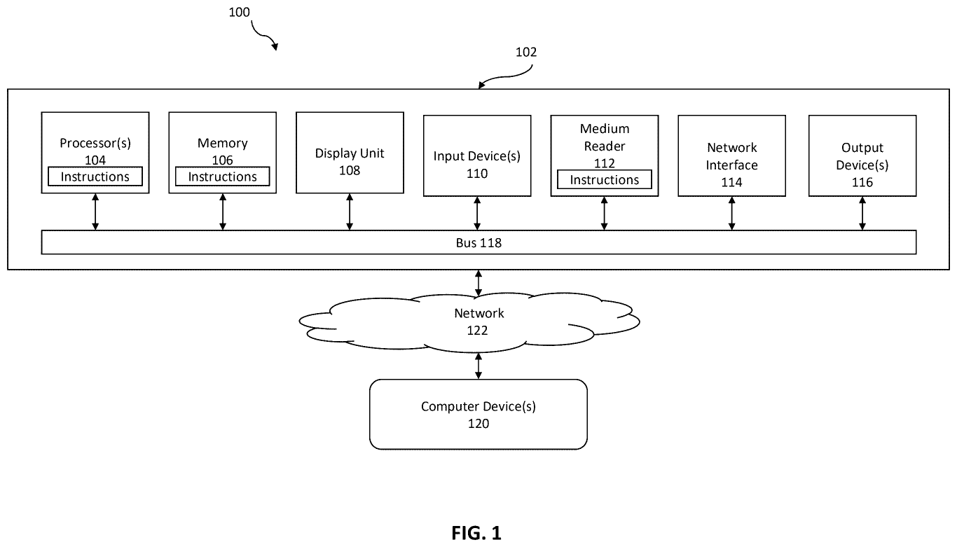

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide methods and systems for assessing a quality of a data fabric.

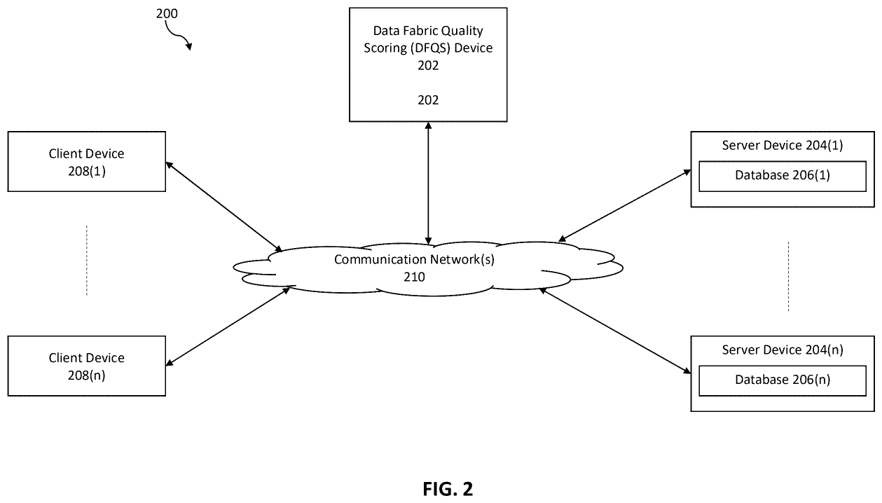

Referring to FIG. 2, a schematic of an exemplary network environment 200 for implementing a method for assessing a quality of a data fabric is illustrated. In an exemplary implementation, the method is executable on any networked computer platform, such as, for example, a personal computer (PC).

The method for assessing the quality of the data fabric may be implemented by a data fabric quality scoring (DFQS) device 202. The DFQS device 202 may be the same or similar to the computer system 102 as described with respect to FIG. 1. The DFQS device 202 may store one or more applications that can include executable instructions that, when executed by the DFQS device 202, cause the DFQS device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the DFQS device 202 itself, may be located in the virtual server(s) running in a cloud-based computing environment rather than being tied to one or more specific physical network computing devices. Also, the application(s) may be running in one or more virtual machines (VMs) executing on the DFQS device 202. Additionally, in one or more embodiments of this technology, virtual machine(s) running on the DFQS device 202 may be managed or supervised by a hypervisor.

In the network environment 200 of FIG. 2, the DFQS device 202 is coupled to a plurality of server devices 204(1)-204(n) that hosts a plurality of databases 206(1)-206(n), and also to a plurality of client devices 208(1)-208(n) via communication network(s) 210. A communication interface of the DFQS device 202, such as the network interface 114 of the computer system 102 of FIG. 1, operatively couples and communicates between the DFQS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DFQS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and DFQS devices that efficiently implement the method for assessing the quality of the data fabric.

By way of example only, the communication network(s) 210 may include local area network(s) (LAN(s)) or wide area network(s) (WAN(s)), and may use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The DFQS device 202 may be a standalone device or integrated with one or more other devices or apparatuses, such as one or more of the server devices 204(1)-204(n), for example. In one particular example, the DFQS device 202 may include or be hosted by one of the server devices 204(1)-204(n), and other arrangements are also possible. Moreover, one or more of the devices of the DFQS device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the DFQS device 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to a plurality of input data products, a data fabric quality scoreboard, and recommendations on quality of data fabric provided by a quality scoring engine.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the DFQS device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the DFQS device 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the DFQS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the DFQS device 202, the server devices 204(1)-204(n), or the client devices 208(1)-208(n), for example, may be configured to operate as virtual instances on the same physical machine. In other words, one or more of the DFQS device 202, the server devices 204(1)-204(n), or the client devices 208(1)-208(n) may operate on the same physical device rather than as separate devices communicating through communication network(s) 210. Additionally, there may be more or fewer DFQS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

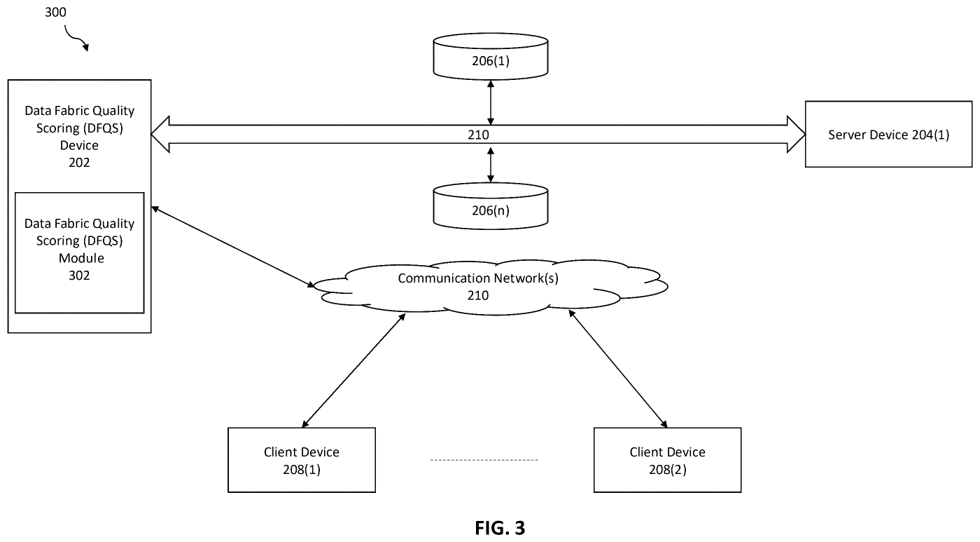

FIG. 3 illustrates an exemplary system for implementing a method for assessing a quality of a data fabric, in accordance with an exemplary embodiment. As illustrated in FIG. 3, according to exemplary implementations, the system 300 may include a data fabric quality scoring (DFQS) device 202 including a data fabric quality scoring (DFQS) module 302 that may be connected to a server device 204(1) and one or more repository from the repositories 206(1) . . . 206(n) via a communication network 210, but the disclosure is not limited thereto.

The DFQS device 202 is described and shown in FIG. 3 as including a DFQS module 302, although it may include other rules, policies, modules, databases, or applications, for example. As will be described below, the DFQS module 302 is configured to implement a method for assessing the quality of the data fabric.

An exemplary system 300 for implementing a mechanism for assessing the quality of the data fabric by utilizing the network environment of FIG. 2 is shown as being executed in FIG. 3. Specifically, a first client device 208(1) and a second client device 208(2) are illustrated as being in communication with the DFQS device 202. In this regard, the first client device 208(1) and the second client device 208(2) may be “clients” of the DFQS device 202 and are described herein as such. Nevertheless, it is to be known and understood that the first client device 208(1) and/or the second client device 208(2) need not necessarily be “clients” of the DFQS device 202, or any entity described in association therewith herein. Any additional or alternative relationship may exist between either or both of the first client device 208(1) and the second client device 208(2) and the DFQS device 202, or no relationship may exist.

Further, the DFQS device 202 is illustrated as being able to access one or more repositories 206(1) . . . 206(n). The DFQS module 302 may be configured to access these repositories/databases for implementing a method for assessing the quality of the data fabric.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the DFQS device 202 via broadband or cellular communication. These embodiments are merely exemplary and are not limiting or exhaustive.

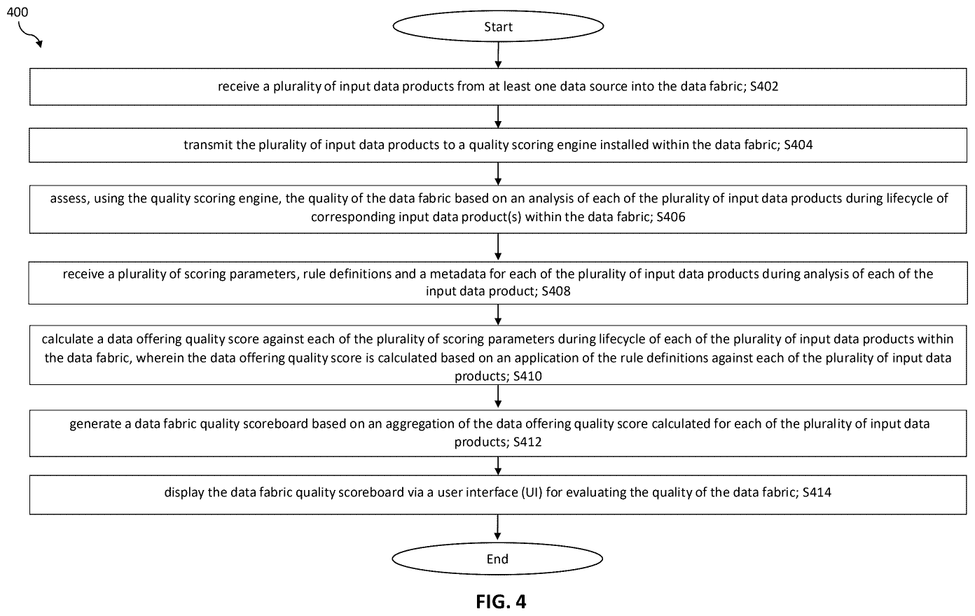

Referring to FIG. 4, an exemplary method 400 is shown for assessing a quality of a data fabric, in accordance with an exemplary embodiment.

As shown in FIG. 4, the method 400 begins following a need for assessing the quality of the data fabric. A user, such as, for example, a technology owner or an end user associated with a data fabric platform, may wish to evaluate the quality of the data fabric to perform various operational workloads. The method 400 is implemented by at least one processor 104.

At step S402, the method 400 includes receiving, by the at least one processor 104, a plurality of input data products from at least one data source into the data fabric. The plurality of input data products includes data owning system details, a predetermined data product (also referred to herein as a “first data product”), and data offering details.

The term “data fabric” herein may correspond to a centralized architecture that facilitates end-to-end data integration and management solutions and serves data consumers with integrated, governed, fresh data for analytical and operational workloads. The at least one data source may include, but is not limited to, any one or more of legacy systems, data lakes, data warehouses, server(s), computers, structured query language (SQL) databases, and applications.

In an exemplary implementation, the method 400 includes receiving the plurality of input data products from a user device operated by the user. In an exemplary implementation, the method 400 includes receiving the plurality of input data products as inputs to the data fabric via a user interface (UI). The user interface may be rendered on a display unit of the user device. The UI may be a graphical user interface (GUI).

In some examples, the user device may include at least one from among a tablet, a smartphone, a laptop, a desktop computer, a mainframe computer, a phablet, a smart watch, a personal digital assistant (PDA), and the like.

In another exemplary implementation, the method for receiving the plurality of input data products may include scanning and processing of physical or electronic documents provided by the user via the user's device. The plurality of input data products may be fetched using a secure data communication protocol from the at least one data source to ensure the integrity and confidentiality of the plurality of the input data products.

At step S404, the method includes transmitting, by the at least one processor 104, the plurality of input data products to a quality scoring engine (also referred to herein as “data fabric quality scoring (DFQS) module”) installed within the data fabric.

The term “quality scoring engine” herein may correspond to a module or engine configured to assess the quality of the data fabric by performing a respective analysis for each of the plurality of input data products.

At step S406, the method includes assessing, by the at least one processor 104 using the quality scoring engine, the quality of the data fabric based on the respective analysis of each of the plurality of input data products during the lifecycle of each corresponding input data product within the data fabric.

Further, the analysis of each of the plurality of input data products within the data fabric may be performed in a sequential manner. It would be appreciated by the person skilled in the art that the aim of the disclosure is to create a more dynamic and accurate data fabric quality measurement system. In an exemplary implementation, the method may include configuring the quality scoring engine via the machine learning (ML) technique.

At step S408, to analyze each of the plurality of input data products, the method includes receiving, by the at least one processor 104, a plurality of scoring parameters, a plurality of rule definitions, and a metadata for each of the plurality of input data products. The plurality of scoring parameters, the plurality of rule definitions, and the metadata for each of the plurality of input data products is received during the analysis of each of the input data products. The plurality of scoring parameters has a set of categories and a set of subcategories for scoring each of the plurality of input data products.

In an exemplary implementation, the set of categories of the plurality of scoring parameters may include at least one from among a data product maturity category, a data product development lifecycle category, a performance optimization category, and a usage category. In an exemplary implementation, the set of subcategories of the plurality of scoring parameters may include at least one from among an onboarding data subcategory, a raw data exposure subcategory, and a data product subcategory. In another exemplary implementation, the set of subcategories of the plurality of scoring parameters may include at least one from among the onboarding data or registering data subcategory, the raw data exposure subcategory, a data product offerings subcategory, a virtual database standards and naming conventions subcategory, a virtual databases definitions and descriptions subcategory, an adoption of continuous integration and continuous delivery/deployment (CI/CD) pipeline for data integration and curation subcategory, an adoption of the CI/CD for handling data subcategory, a periodic refresh of physical data layer statistics subcategory, a relationships between data product offering subcategory, a relationships between curated/refined data product offerings subcategory, a number of users providing input subcategory, and a queries raised by users per day subcategory. In an exemplary implementation, the set of subcategories of the data product development life cycle category may include at least one from among the virtual database standards and naming conventions subcategory, a virtual databases definitions and descriptions subcategory, the adoption of continuous integration and continuous delivery/deployment (CI/CD) pipeline for data integration and curation subcategory, and the adoption of the CI/CD for handling data subcategory. The set of subcategories of the performance optimization category may include at least one from among the periodic refresh of physical data layer statistics subcategory, the relationships between data product offerings subcategory, and the relationships between curated/refined data product offerings subcategory. The set of subcategories of the usage category may be defined by the number of users providing input subcategory and the number of queries raised by users per day subcategory.

In an exemplary implementation, the metadata may include at least one from among a data owning system identifier, a data owning system name, a data owning system description, a data domain name, a data domain description, a data offering identifier, and a data offering name.

In an exemplary implementation, the method includes customizing, by the at least one processor 104, each of the plurality of rule definitions based on a type of the plurality of input data products. The rule definitions are a predefined set of rules. The rule definitions may be customized and defined as per the data fabric quality measures and requirements. The quality scoring engine uses the flexible category, sub category definitions (for example, the category and subcategory) and runs the predefined set of rules against the plurality of input data products to allocate the score for each of the plurality of input data products. In an exemplary implementation, the below table represents examples of data fabric quality rule definitions.

| | | | Sub | | |
|---|---|---|---|---|---|
| Rule | | Category | Category | Rule | |
| Identifier | Rule Name | Name | Name | Description | Rule Definition |
| R1 | rule | data | onboarding | sample rule | if <data offering_{—} |
| | onboarding | product | data | description | type> is blank |
| | not started | maturity | | for setting | then set <data |
| | | | | the onboarding | fabric quality |
| | | | | to not | score code> = Not |
| | | | | started | started |
| R2 | rule_rawdata_{—} | data | raw data | sample rule | if <data offering_{—} |
| | exposure_{—} | product | exposure | description | type> is raw then |
| | foundational | maturity | | for setting | set <data fabric |
| | | | | the raw data | quality score |
| | | | | exposure to | code> = matured |
| | | | | matured | |
| R3 | rule_raw_data_{—} | data | raw data | sample rule | if <data offering_{—} |
| | exposure_{—} | product | exposure | description | type> is ‘derived’ |
| | matured | maturity | | for setting | and #queries per |
| | | | | the raw data | day is >100 then |
| | | | | exposure to | set <data fabric |
| | | | | matured | quality score |
| | | | | | code> = matured |
| R4 | rule_data_{—} | data | data product | sample rule | if data_offering_{—} |
| | product_{—} | product | offerings | description | type = ‘curated’ |
| | offerings | maturity | | for setting | and tag = certified |
| | | | | the data | by CDO then set |
| | | | | product | <data fabric quality |
| | | | | offerings to | score code> = matured |
| | | | | matured | |

It would be appreciated by the person skilled in the art that the goal herein is to assess the quality of the data fabric. As the application (e.g., the input data products) progresses the journey within the data fabric, the disclosed method allocates a score for each milestone that is accomplished by the application and tracks the journey from foundational to mature. Moreover, the system disclosed in the present disclosure may be extended to various data fabric implementations to measure the maturity, and this, in turn, helps to understand the overall strength of the data fabric.

At step S410, the method includes calculating, by the at least one processor 104, a respective data offering quality score against each of the plurality of scoring parameters during the lifecycle of each of the plurality of input data products within the data fabric.

The method includes calculating, by the at least processor 104, each respective data offering quality score based on an application of the rule definitions against each of the plurality of input data products. In an exemplary implementation, the quality scoring engine is employed with a rule engine, and the rule engine is configured to calculate the respective data offering quality scores.

At step S412, the method includes generating, by the at least one processor 104, a data fabric quality scoreboard based on an aggregation of the respective data offering quality scores calculated for each of the plurality of input data products.

The data fabric quality scoreboard provides aggregates of scores across all the plurality of input data products. The method as disclosed in the present disclosure uses the data fabric quality scoring module that allocates scores across these measures for each of the input data products that is integrated within the data fabric. This way, the method disclosed in the present disclosure allows to measure and track the quality of the data fabric as a whole. In an exemplary implementation, the below table represents examples of data fabric scores.

| data owning | data owning | data | | data fabric | data fabric |
|---|---|---|---|---|---|
| system | system | offering | data offering | state - sub | quality |
| identifier | name | identifier | name | category name | score code |
| A1 | app1 | DO1 | <application | onboarding | not started |
| | | | name>_positions | data | |
| A2 | app2 | DO2 | <application | raw data | matured |
| | | | name>_transactions | exposure | |
| A3 | app3 | DO3 | <application | data product | matured |
| | | | name>_credit_{—} | offerings | |
| | | | transactions | | |
| A4 | app4 | DO4 | <application | data product | accelerating |
| | | | name>_security_{—} | offerings | |
| | | | purchase_transactions | | |

At step S414, the method includes displaying, by the at least one processor 104, the data fabric quality scoreboard via the user interface (UI) for evaluating the quality of the data fabric. For example, the UI displays the data fabric quality scoreboard to the user so that the user is able to monitor and track the maturity level of the data integration and consumption in the data fabric. This way, the UI allows the user to check and track the quality of the data fabric as a whole. This display of the data fabric quality could be rendered on various types of display units, such as a computer monitor, tablet, or even a smartphone.

Furthermore, the method may include transmitting, by the at least one processor 104 via the display unit, a notification to the user device of the user to alert the user about the data fabric quality scoreboard. The notification may be customized to be delivered via various channels, such as email, short message service (SMS), or even as a push notification from an application.

The method provides the user with an immediate and transparent overview of the quality of the data fabric, enabling the user to visually track and evaluate each of the input data products within the data fabric.

The UI may also present options to the user allowing the export of the data fabric quality scoreboard in various formats such as portable document format (PDF), or to send it directly to relevant parties (for example, a user) via email or other secure channels.

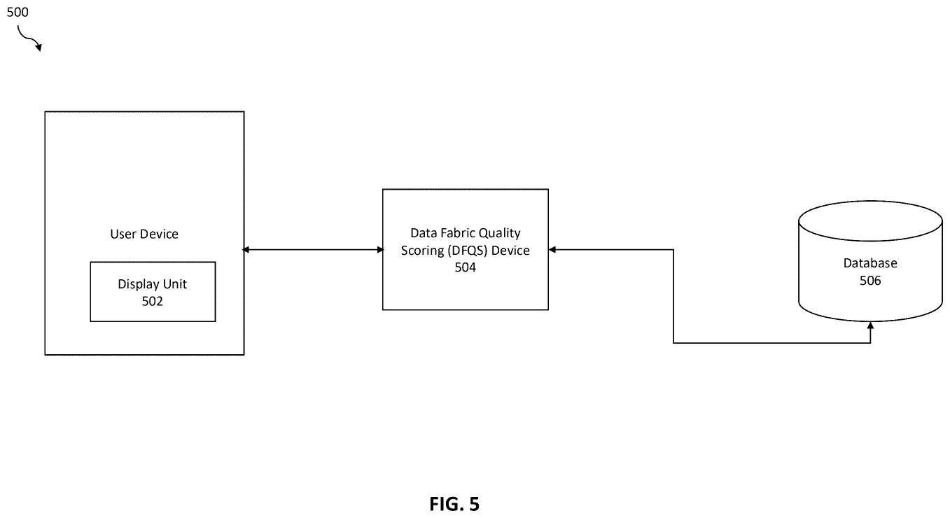

FIG. 5 illustrates a process flow diagram usable for assessing a quality of a data fabric, in accordance with an exemplary embodiment. As illustrated in FIG. 5, the process flow 500 begins with receiving, by a data fabric quality scoring (DFQS) device 504, a plurality of input data products from at least one data source into the data fabric. The aim is to assess or measure the quality of the data fabric. The plurality of input data products includes data owning system details, a predetermined data product, and data offering details.

The DFQS device 504 may fetch additional data required for the implementation of features of the present disclosure from external sources, including, for example, database 506.

The DFQS device 504 is configured to assess, using a quality scoring engine, the quality of the data fabric based on an analysis of each of the plurality of input data products during the lifecycle of the corresponding input data product(s) within the data fabric. To analyze each of the input data products, the DFQS device is configured to receive a plurality of scoring parameters, a plurality of rule definitions, and a metadata for each of the plurality of input data products. Further, the DFQS device 504 is configured to calculate a respective data offering quality score against each of the plurality of scoring parameters during the lifecycle of each of the plurality of input data products within the data fabric, each respective data offering quality score being calculated based on an application of the rule definitions against each of the plurality of input data products. The DFQS device 504 is configured to generate a data fabric quality scoreboard based on an aggregation of the respective data offering quality scores calculated for each of the plurality of input data products, and finally the DFQS device 504 is configured to display the data fabric quality scoreboard via a user interface (UI) to evaluate the quality of the data fabric.

In an exemplary implementation, the user interface (UI) is operated by a user (also referred to as end user or product owner) to monitor and track each of the plurality of input data products. The UI may be a graphical user interface (GUI). For example, the UI may be rendered on a display unit 502 of a user device.

It would be appreciated by the person skilled in the art that the DFQS device 504 offers a full-circle, adaptable, and intelligent solution for automating the highly complex task of assessing the quality of the data fabric.

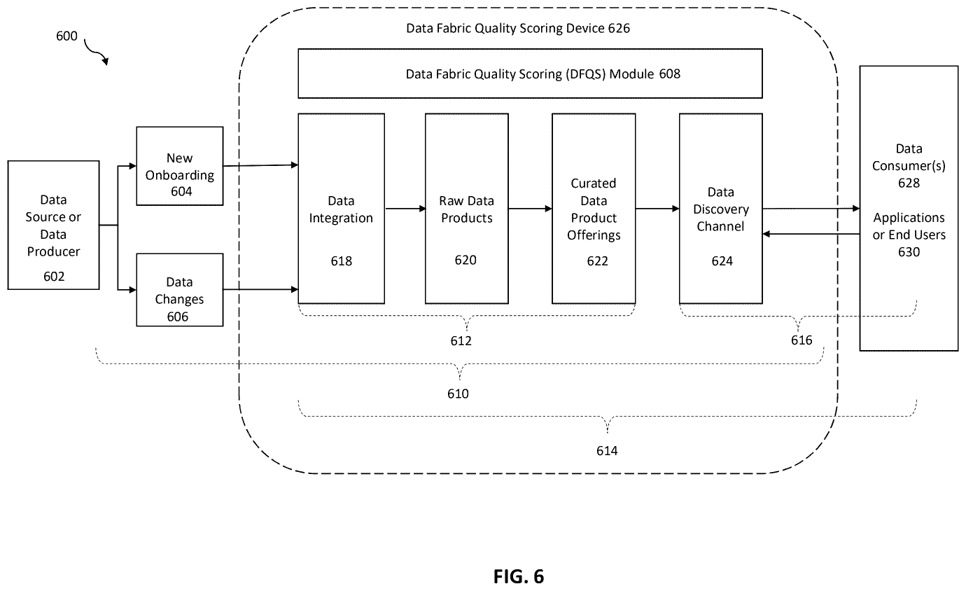

FIG. 6 illustrates an exemplary system flow diagram of a data fabric quality scoring (DFQS) module for assessing a quality of a data fabric, in accordance with an embodiment of the present disclosure. As illustrated in FIG. 6, the system flow 600 begins with receiving a plurality of input data products from at least one data source or data producer 602. Further, at least one processor is configured to execute a new onboarding process 604 for the plurality of input data products. Further, the at least one processor checks for data changes 606 in a system while assessing the quality of the data fabric.

In an exemplary implementation, the DFQS module 608 may be installed in a data fabric quality scoring device 626. The DFQS module 608 is configured to calculate a respective data offering quality score against a plurality of scoring parameters during the lifecycle of each of the plurality of input data products within the data fabric. The plurality of scoring parameters includes a set of categories (of measures) and a set of subcategories. In an exemplary implementation, the set of categories of the plurality of scoring parameters includes at least one from among a data product development lifecycle category 610, a data product maturity category 612, a performance optimization category 614, and a usage category 616. The DFQS module allocates scores for each of the categories (e.g., the data product development lifecycle category 610, the data product maturity category 612, the performance optimization category 614, and the usage category 616) within the data fabric to enhance the reliability of measurement of the data fabric quality for the plurality of data products.

In an exemplary implementation, the set of subcategories of the plurality of scoring parameters includes at least one from among an onboarding data subcategory, a raw data exposure subcategory, and a data product offering subcategory. In an example, the onboarding data subcategory is a first subcategory of the plurality of scoring parameters, the raw data exposure subcategory is a second subcategory of the plurality of scoring parameters, and the data product offering subcategory is a third subcategory of the plurality of scoring parameters.

The DFQS module 608 is configured to measure and score data product offerings/data products across each stage of the data fabric. Starting from a data integration stage 618 where different disparate data sources (for example data source or data producer 602) are integrated. Once the required connectivity to relevant data sources is established, a metadata for raw data sources, specifying the data types, relationships, and other required information is defined in raw data products stage 620. The next stage is a curated data product offerings stage 622 where the raw data products 620 are transformed into meaningful, accessible insights through transformations, normalizations, or other standardizations as required. A data discovery channel stage 624 provides access to authorized users (or data consumers 628 or applications or end users 630) so that the authorized users may access required data through the data discovery channel stage 624.

In an exemplary implementation, data product maturity category is indicated as 612 in FIG. 6. The data product maturity category 612 includes the process in a phase of data integration, raw data products, and curated data product offerings. In FIG. 6, the data product development lifecycle category is indicated as 610. The data product development lifecycle category 610 includes the process starting from the at least one data source 602 to the data discovery channel. In FIG. 6, the performance optimization category is indicated as 614. The performance optimization category 614 includes the process starting from the data integration stage 618 to the data consumers 628. In FIG. 6, the usage category is indicated as 616. The usage category 616 includes the process between the data discovery channel stage 624 and the data consumers 628.

The present disclosure provides numerous advantages as given below: The present disclosure allows organizations to realize the data fabric maturity model. The present disclosure provides a method that allows users to track and monitor the journey of each of the plurality of input data products within the data fabric. The present disclosure provides transparency across data sources on their stages of progression within the data fabric. The present disclosure may be customized for various data fabric technology stacks. The present disclosure provides flexibility to add and/or adopt rules as required.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated via a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for assessing quality of a data fabric is disclosed. The instructions include executable code which, when executed by a processor 104, may cause the processor 104 to receive a plurality of input data products from at least one data source into the data fabric; transmit the plurality of input data products to a quality scoring engine installed within the data fabric; assess, using the quality scoring engine, quality of the data fabric based on an analysis of each of the plurality of input data products during lifecycle of the corresponding input data product(s) within the data fabric, the analysis of each of the input data product includes: receive a plurality of scoring parameters, rule definitions and a metadata for each of the plurality of input data products; calculate a data offering quality score against each of the plurality of scoring parameters during lifecycle of each of the plurality of input data products within the data fabric, the data offering quality score is calculated based on an application of the rule definitions against each of the plurality of input data products; generate a data fabric quality scoreboard based on an aggregation of the data offering quality score calculated for each of the plurality of input data products; and display the data fabric quality scoreboard via a user interface (UI) to evaluate quality of the data fabric.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing detailed description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the detailed description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

We claim:

1. A method for assessing a quality of a data fabric, the method being implemented by at least one processor, the method comprising:
receiving, by the at least one processor, a plurality of input data products from at least one data source into the data fabric;
transmitting, by the at least one processor, the plurality of input data products to a quality scoring engine installed within the data fabric; and
assessing, by the at least one processor using the quality scoring engine, the quality of the data fabric based on an analysis of each of the plurality of input data products during a lifecycle of each corresponding input data product within the data fabric,
wherein the analysis of each of the plurality of input data products comprises:
receiving, by the at least one processor, a plurality of scoring parameters, a plurality of rule definitions, and a metadata for each of the plurality of input data products;
calculating, by the at least one processor, a respective data offering quality score against each of the plurality of scoring parameters during the lifecycle of each of the plurality of input data products within the data fabric, wherein each respective data offering quality score is calculated based on an application of the plurality of rule definitions against each of the plurality of input data products;
generating, by the at least one processor, a data fabric quality scoreboard based on an aggregation of the respective data offering quality scores calculated for each of the plurality of input data products; and
displaying, by the at least one processor, the data fabric quality scoreboard via a user interface (UI) for evaluating the quality of the data fabric.

2. The method as claimed in claim 1, wherein the plurality of input data products comprises data owning system details, a first data product, and data offering details.

3. The method as claimed in claim 1, wherein the analysis of each of the plurality of input data products within the data fabric is performed in a sequential manner.

4. The method as claimed in claim 1, wherein the plurality of scoring parameters comprises a set of categories and a set of subcategories, and wherein the set of categories of the plurality of scoring parameters comprises at least one from among a data product maturity category, a data product development lifecycle category, a performance optimization category, and a usage category.

5. The method as claimed in claim 4, wherein the set of subcategories of the plurality of scoring parameters comprises at least one from among an onboarding data subcategory, a raw data exposure subcategory, and a data product offering subcategory.

6. The method as claimed in claim 1, wherein the metadata comprises at least one from among a data owning system identifier, a data owning system name, a data owning system description, a data domain name, a data domain description, a data offering identifier, and a data offering name.

7. The method as claimed in claim 1, wherein each of the plurality of rule definitions is customized based on a type of the plurality of input data products.

8. A computing device configured to implement an execution of a method for assessing a quality of a data fabric, the computing device comprising:
a processor;
a memory; and
a communication interface coupled to each of the processor and the memory,
wherein the processor is configured to:
receive a plurality of input data products from at least one data source into the data fabric;
transmit the plurality of input data products to a quality scoring engine installed within the data fabric; and
assess, using the quality scoring engine, the quality of the data fabric based on an analysis of each of the plurality of input data products during a lifecycle of each corresponding input data product within the data fabric,
wherein to perform the analysis of each of the plurality of input data products, the processor is further configured to:
receive a plurality of scoring parameters, a plurality of rule definitions, and a metadata for each of the plurality of input data products;
calculate a respective data offering quality score against each of the plurality of scoring parameters during the lifecycle of each of the plurality of input data products within the data fabric, wherein each respective data offering quality score is calculated based on an application of the plurality of rule definitions against each of the plurality of input data products;
generate a data fabric quality scoreboard based on an aggregation of the respective data offering quality scores calculated for each of the plurality of input data products; and
display the data fabric quality scoreboard via a user interface (UI) to evaluate the quality of the data fabric.

9. The computing device as claimed in claim 8, wherein the plurality of input data products comprises data owning system details, a first data product, and data offering details.

10. The computing device as claimed in claim 8, wherein the analysis of each of the plurality of input data products within the data fabric is performed in a sequential manner.

11. The computing device as claimed in claim 8, wherein the plurality of scoring parameters comprises a set of categories and a set of subcategories, and wherein the set of categories of the plurality of scoring parameters comprises at least one from among a data product maturity category, a data product development lifecycle category, a performance optimization category, and a usage category.

12. The computing device as claimed in claim 11, wherein the set of subcategories of the plurality of scoring parameters comprises at least one from among an onboarding data subcategory, a raw data exposure subcategory, and a data product offering subcategory.

13. The computing device as claimed in claim 8, wherein the metadata comprises at least one from among a data owning system identifier, a data owning system name, a data owning system description, a data domain name, a data domain description, a data offering identifier, and a data offering name.

14. The computing device as claimed in claim 8, wherein each of the plurality of rule definitions is customized based on a type of the plurality of input data products.

15. A non-transitory computer readable storage medium storing instructions for assessing a quality of a data fabric, the storage medium comprising executable code which, when executed by a processor, causes the processor to:
receive a plurality of input data products from at least one data source into the data fabric;
transmit the plurality of input data products to a quality scoring engine installed within the data fabric; and
assess, using the quality scoring engine, the quality of the data fabric based on an analysis of each of the plurality of input data products during a lifecycle of each corresponding input data product within the data fabric,
wherein to perform the analysis of each of the plurality of input data products, the processor is further caused to:
receive a plurality of scoring parameters, a plurality of rule definitions, and a metadata for each of the plurality of input data products;
calculate a respective data offering quality score against each of the plurality of scoring parameters during the lifecycle of each of the plurality of input data products within the data fabric, wherein each respective data offering quality score is calculated based on an application of the plurality of rule definitions against each of the plurality of input data products;
generate a data fabric quality scoreboard based on an aggregation of the respective data offering quality scores calculated for each of the plurality of input data products; and
display the data fabric quality scoreboard via a user interface (UI) to evaluate the quality of the data fabric.

16. The storage medium as claimed in claim 15, wherein the plurality of input data products comprises data owning system details, a first data product, and data offering details.

17. The storage medium as claimed in claim 15, wherein the analysis of each of the plurality of input data products within the data fabric is performed in a sequential manner.

18. The storage medium as claimed in claim 15, wherein the plurality of scoring parameters comprises a set of categories and a set of subcategories, and wherein the set of categories of the plurality of scoring parameters comprises at least one from among a data product maturity category, a data product development lifecycle category, a performance optimization category, and a usage category, and the set of subcategories of the plurality of scoring parameters comprises at least one from among an onboarding data subcategory, a raw data exposure subcategory, and a data product offering subcategory.

19. The storage medium as claimed in claim 15, wherein the metadata comprises at least one from among a data owning system identifier, a data owning system name, a data owning system description, a data domain name, a data domain description, a data offering identifier, and a data offering name.

20. The storage medium as claimed in claim 15, wherein each of the plurality of rule definitions is customized based on a type of the plurality of input data products.
